(19) United States
(12) Patent Application Publication
(10) Pub. No.: US 2026/0229789 A1
(43) Pub. Date: Aug. 6, 2026

(54) ANTENNA STRUCTURE AND COMMUNICATION SYSTEM

(71) Applicant: BOE Technology Group Co., Ltd., Beijing (CN)

(72) Inventors: Jianxing LIU, Beijing (CN); Xin JIN, Beijing (CN); Feng QU, Beijing (CN)

(21) Appl. No.: 19/149,832

(22) PCT Filed: Jun. 25, 2024
(86) PCT No.: PCT/CN2024/101347

§ 371 Date: Jul. 21, 2025

(30) Foreign Application Priority Data
Jul. 31, 2023 (CN) 202310955337.7

(51) Int. Cl. H01Q 19/10; H01Q 9/04; H01Q 21/08

(52) U.S. Cl. CPC H01Q 19/10; H01Q 9/0407; H01Q 21/08

(57) ABSTRACT

An antenna structure and a communication system. The antenna structure includes two antenna assemblies (1) spaced apart from each other in a first direction. The two antenna assemblies (1) are arranged symmetrically about a first plane (9) located between the two antenna assemblies (1). The first direction is set to be perpendicular to the first plane (9). Each antenna assembly (1) includes at least two antenna units (2) spaced apart from each other. Each antenna unit (2) includes a reflecting plate (4) and a patch mechanism (5) which are connected to each other. The patch mechanism (5) is located on the side of the reflecting plate (4) facing away from the first plane (9). The communication system includes the antenna structure.

### CROSS-REFERENCE TO RELATED APPLICATION

This application is a U.S. National Phase Entry of International Application No. PCT/CN2024/101347 having an international filing date of Jun. 25, 2024, which claims the priority of a Chinese Patent Application No. 202310955337.7, filed on Jul. 31, 2023 and entitled “Antenna Structure and Communication System”. Contents of the above-identified applications are incorporated herein by reference.

### TECHNICAL FIELD

The present disclosure relates to, but is not limited to, the field of communications, and particularly relates to an antenna structure and a communication system.

### BACKGROUND

Dual-polarized omnidirectional antenna is a new antenna technology, which combines two antennas with orthogonal polarization directions of +45° and −45° and works in transceiver duplex mode at the same time. Therefore, the most prominent advantage of the dual-polarized omnidirectional antenna is that it saves the number of antennas in a single directional base station.

At present, the structure of dual-polarized omnidirectional antennas is complex, has the high cost, and is inconvenient to disassemble and assemble. Moreover, in order to ensure the gain, the number of antenna units needs to be increased. As a result, the overall size of dual-polarized omnidirectional antennas is larger, the windward area is larger, and the possibility of being damaged by the natural environment is greater.

### SUMMARY

The following is a summary of subject matters described herein in detail. This summary is not intended to limit the protection scope of claims.

At least one embodiment of the present disclosure provides an antenna structure including two antenna assemblies spaced apart in a first direction, the two antenna assemblies are configured to be symmetrical relative to a first plane located between the two antenna assemblies, and the first direction is configured to be perpendicular to the first plane.

The antenna assemblies include at least two antenna units spaced apart, each antenna unit includes a reflecting plate and a patch mechanism that are connected to each other, and the patch mechanism is located on a side of the reflecting plate facing away from the first plane.

In some exemplary embodiments, the antenna assemblies further include a connector, reflecting plates of two adjacent antenna units are configured to be connected through the connector, and the two adjacent antenna units are configured to be symmetrical relative to the connector.

In some exemplary embodiments, the reflecting plates of the at least two antenna units are located in a second plane and are spaced apart, the connector is configured to have a plate shape and is located in the second plane, and the second plane is parallel to the first plane.

In some exemplary embodiments, the connector is provided as an integral piece with the reflecting plates of the two adjacent antenna units, and a thickness of the connector is the same as a thickness of the reflecting plate.

In some exemplary embodiments, the connector is provided with a first slot that is configured to penetrate the connector in the first direction, and the first slot is arranged centrally on the connector.

In some exemplary embodiments, the first slot includes a plurality of first transverse slots and a plurality of first vertical slots. The plurality of first transverse slots are parallel to each other and arranged at equal intervals along a second direction, and the plurality of first vertical slots are parallel to each other and arranged at equal intervals along a third direction. The plurality of first transverse slots and the plurality of first vertical slots intersect to form a mesh shape, and the first direction, the second direction, and the third direction are configured to be perpendicular to each other.

In some exemplary embodiments, two antenna units are provided, the two antenna units are spaced apart in a second direction, reflecting plates of the two antenna units are each provided with a reflecting sheet perpendicular thereto, and the reflecting sheet and the reflecting plate are provided as an integral piece.

An edge of the reflecting plate away from the connector in the second direction is provided as a third edge, one end of the reflecting sheet is connected with the third edge, the other end of the reflecting sheet extends away from the first plane, and the second direction is perpendicular to the first direction.

In some exemplary embodiments, a length of the reflecting sheet is configured to be the same as an extension length of the third edge, and one end of the reflecting sheet away from the reflecting plate is configured to have a distance H from the reflecting plate, wherein 10 mm<H<15 mm.

In some exemplary embodiments, the patch mechanism includes a dielectric plate and a radiation patch, the radiation patch is configured to be parallel to the reflecting plate and to be spaced apart from the reflecting plate in the first direction, the dielectric plate is sandwiched between the radiation patch and the reflecting plate, and both the dielectric plate and the radiation patch are configured to be arranged centrally relative to the reflecting plate.

The radiation patch has two feeding ports rotationally symmetrical at 90° relative to a geometric center of the radiation patch.

In some exemplary embodiments, a projection of the dielectric plate on the first plane is configured to be located within a projection of the reflecting plate on the first plane, and a projection of the radiation patch on the first plane is located within the projection of the dielectric plate on the first plane.

In some exemplary embodiments, the reflecting plate, the dielectric plate, and the radiation patch are all configured as a plate-like structure having a same shape. Edges of the connector at both ends in a second direction are provided as first edges, the first edges are configured to be connected with the reflecting plate, and an extension length of each first edge is configured to be equal to or less than an extension length of an edge of the reflecting plate close to the connector.

In some exemplary embodiments, the radiation patch is provided with a second slot, and the second slot is arranged centrally on the radiation patch and penetrates the radiation patch.

In some exemplary embodiments, the second slot is provided as a cross-shaped slot, and the cross-shaped slot includes a second transverse slot and a second vertical slot that intersect.

In some exemplary embodiments, slot widths of the second transverse slot and the second vertical slot are both configured to be 1 mm to 2 mm, slot lengths of the second transverse slot and the second vertical slot are both L₁, the second transverse slot or the second vertical slot is configured to extend in the second direction, and an extension length of the radiation patch in the second direction is configured to be L₂. L₁:L₂=1:2, and the second direction is configured to be perpendicular to the first direction.

In some exemplary embodiments, a metal member is provided between the radiation patch and the reflecting plate, the radiation patch and the reflecting plate are configured to be electrically connected via the metal member, and the metal member is embedded in the dielectric plate.

In some exemplary embodiments, the metal member is provided as a metal sheet, the metal sheet is perpendicular to the reflecting plate and the radiation patch and is attached to the reflecting plate and the radiation patch at both ends in the first direction, and the dielectric plate is provided with an embedding slot for accommodating the metal sheet.

One edge of the radiation patch in a third direction is provided as a second edge, and the two feeding ports are configured to be away from the second edge. The metal sheet extends along the third direction, the metal sheet is configured to be arranged centrally in a second direction relative to the radiation patch, one end of the metal sheet is flush with the second edge, and the first direction, the second direction, and the third direction are configured to be perpendicular to each other.

In some exemplary embodiments, the patch mechanism further includes a parasitic patch and a foam pad, the parasitic patch is located on a side of the radiation patch facing away from the reflecting plate, the parasitic patch is parallel to the radiation patch and is spaced apart from the radiation patch in the first direction, and the foam pad is sandwiched between the parasitic patch and the radiation patch.

In some exemplary embodiments, both the parasitic patch and the foam pad are configured to have a square plate shape.

A projection of the radiation patch on the first plane is located in a projection range of the parasitic patch on the first plane.

A projection of the foam pad on the first plane is the same as the projection of the radiation patch on the first plane.

In some exemplary embodiments, the feeding ports are coaxial feeding ports, and a phase difference between the two feeding ports is 180°.

In some exemplary embodiments, one end of the feeding ports penetrates the radiation patch and is welded to the radiation patch at an end face of the radiation patch facing away from the reflecting plate, and the other end of the feeding ports penetrates the reflecting plate.

In some exemplary embodiments, a distance between two adjacent antenna assemblies is configured to be 10 mm to 50 mm.

In some exemplary embodiments, in one of the antenna assemblies, a total area of a projection of the connector and the reflecting plate of the antenna unit on the first plane is configured to be 0.1 m² to 0.15 m².

Other aspects of the present disclosure may be comprehended after the drawings and the detailed descriptions are read and understood.

### BRIEF DESCRIPTION OF DRAWINGS

FIG. 1 is a schematic diagram of an antenna structure according to an embodiment of the present disclosure;

FIG. 2 is a side view of the antenna structure of FIG. 1;

FIG. 3 is a front view of the antenna assembly of FIG. 1;

FIG. 4 is a schematic cross-sectional view taken along an A-A direction of FIG. 3;

FIG. 5 is a partial schematic diagram of FIG. 4;

FIG. 6 is a schematic diagram of the antenna unit of FIG. 1;

FIG. 7 is a front view of the antenna unit of FIG. 6;

FIG. 8 is a schematic diagram of an antenna structure according to another embodiment of the present disclosure;

FIG. 9 is a schematic diagram of an antenna structure according to further another embodiment of the present disclosure;

FIG. 10 is a schematic diagram of an antenna structure according to yet another embodiment of the present disclosure;

FIG. 11 is a schematic diagram of an antenna structure according to still yet another embodiment of the present disclosure;

FIG. 12 is a schematic diagram of an antenna structure according to still yet another embodiment of the present disclosure;

FIG. 13 is a schematic diagram of an antenna structure according to still yet another embodiment of the present disclosure;

FIG. 14 is a schematic diagram of the radiation patch of FIG. 8;

FIG. 15 is a schematic diagram of an antenna structure according to still yet another embodiment of the present disclosure;

FIG. 16 is a schematic diagram of an antenna structure according to still yet another embodiment of the present disclosure;

FIG. 17 is a schematic diagram of an antenna structure according to still yet another embodiment of the present disclosure;

FIG. 18 is a schematic diagram of an antenna structure according to still yet another embodiment of the present disclosure;

FIG. 19 is a schematic diagram of an antenna structure according to still yet another embodiment of the present disclosure;

FIG. 20 is a schematic cross-sectional view taken along a B-B direction of FIG. 19;

FIG. 21 is a schematic diagram of the dielectric plate of FIG. 19;

FIG. 22 is a partial schematic diagram of FIG. 20;

FIG. 23 is a schematic diagram of an antenna structure according to still yet another embodiment of the present disclosure;

FIG. 24 is a partial schematic diagram of the antenna structure of FIG. 23;

FIG. 25 is a schematic diagram of an antenna structure according to still yet another embodiment of the present disclosure;

FIG. 26 is a partial schematic diagram of the antenna structure of FIG. 25;

FIG. 27 is a schematic diagram of an antenna structure according to still yet another embodiment of the present disclosure;

FIG. 28 is a schematic diagram of an antenna structure according to still yet another embodiment of the present disclosure;

FIG. 29 is an antenna pattern of the antenna structure shown in FIG. 1;

FIG. 30 is a schematic diagram of a Realizd Gain simulation of the antenna structure shown in FIG. 1;

FIG. 31 is an antenna pattern of the antenna structure shown in FIG. 17; and

FIG. 32 is another antenna pattern of the antenna structure shown in FIG. 1.

Reference signs are described as follows.
1—antenna assembly, 2—antenna unit, 3—connector, 4—reflecting plate, 5—patch mechanism, 6—dielectric plate, 7—radiation patch, 8—feeding port, 9—first plane, 10—first edge, 11—third edge, 12—first through hole, 13—second through hole, 14—third through hole, 15—second edge, 16—second slot, 17—second transverse slot, 18—second vertical slot, 19—first slot, 20—first transverse slot, 21—first vertical slot, 22—metal member, 23—embedding slot, 24—foam pad, 25—parasitic patch, 26—reflecting sheet, 27—metal sheet, 28—transition plate, 29—fourth edge, 30—inclined slot, 31—circular via.

### DETAILED DESCRIPTION

To make objectives, technical solutions, and advantages of the present disclosure clearer, the embodiments of the present disclosure will be described in detail below with reference to the accompanying drawings. It is to be noted that implementations may be implemented in multiple different forms. Those of ordinary skills in the art may easily understand such a fact that implementations and contents may be transformed into various forms without departing from the purpose and scope of the present disclosure. Therefore, the present disclosure should not be explained as being limited to the contents recorded in the following implementations only. The embodiments and features in the embodiments of the present disclosure may be randomly combined with each other if there is no conflict.

Ordinal numerals “first”, “second”, “third”, and the like in the specification are set not to form limits in numbers but only to avoid confusion between constituent elements.

In the specification, for convenience, expressions “central”, “above”, “below”, “front”, “back”, “vertical”, “horizontal”, “top”, “bottom”, “inside”, “outside”, and the like for indicating directional or positional relationships are used to illustrate positional relationships between the constituent elements with reference to the accompanying drawings, not to indicate or imply that involved devices or elements are required to have specific orientations or are structured and operated in the specific orientations but only to easily describe the present specification and simplify the description, and thus should not be understood as limitations on the present disclosure. The positional relationships between the constituent elements may be changed as appropriate based on a direction according to which each constituent element is described. Therefore, appropriate replacements based on situations are allowed, which is not limited to the expressions in the specification.

In the specification, unless otherwise explicitly specified and defined, terms “mounting”, “coupling”, and “connection” should be understood in a broad sense. For example, a connection may be a fixed connection, or a detachable connection, or an integral connection; it may be a mechanical connection or an electrical connection; it may be a direct connection, or an indirect connection through a middleware, or an internal communication between two elements. Those of ordinary skills in the art may understand specific meanings of the above terms in the present disclosure according to specific situations.

In the specification, “parallel” refers to a state in which an angle formed by two straight lines is above −10° and below 10°, and thus may include a state in which the angle is above −5° and below 5°. In addition, “perpendicular” refers to a state in which an angle formed by two straight lines is above 80° and below 100°, and thus may include a state in which the angle is above 85° and below 95°.

A triangle, rectangle, trapezoid, pentagon, or hexagon, or the like in the specification is not strictly defined, and it may be an approximate triangle, rectangle, trapezoid, pentagon, or hexagon, or the like. There may be some small deformations caused by tolerance, and there may be a chamfer, an arc edge, deformation, etc.

In the present disclosure, “about” means that a boundary is not defined so strictly and numerical values within process and measurement error ranges are allowed.

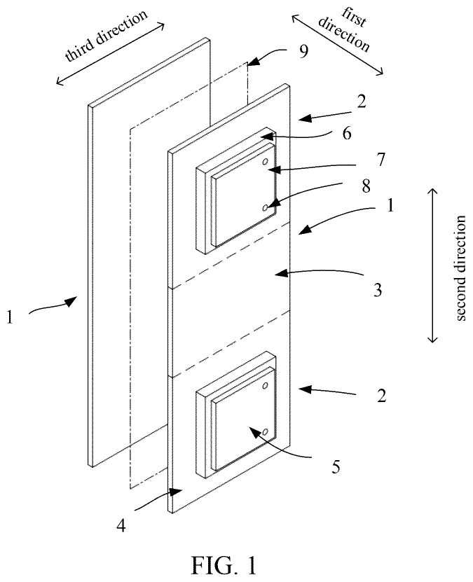

An antenna structure as shown in FIG. 1 may include two antenna assemblies 1 spaced apart in a first direction, the two antenna assemblies 1 may be configured to be arranged symmetrically relative to a first plane 9 located between the two antenna assemblies 1, and the first direction is configured to be perpendicular to the first plane. The antenna assembly 1 may include at least two antenna units 2 spaced apart, the antenna units 2 may include a reflecting plate 4 and a patch mechanism 5 that are connected to each other, and the patch mechanism 5 may be located on a side of the reflecting plate 4 facing away from the first plane 9. Therefore, the antenna structure can realize omnidirectional coverage only with antenna assemblies 1 on both sides, and the antenna structure has a smaller volume and a simpler structure compared with the related dual-polarized omnidirectional antenna on the basis of ensuring gain.

In some exemplary embodiments, as shown in FIGS. 1 and 2, the two antenna assemblies 1 are arranged symmetrically relative to the first plane 9, distances from the two antenna assemblies 1 to the first plane 9 are equal, and a distance between the two antenna assemblies 1 is configured to be D. In this example, the numerical value of D may be set to 40 mm, but is not limited thereto, for example, the numerical value of D may be other numerical values greater than 10 mm.

In some exemplary embodiments, as shown in FIGS. 1 and 2, the antenna assembly 1 may include a connector 3 in addition to the antenna unit 2, and the reflecting plates 4 of the two adjacent antenna units 2 may be configured to be connected by the connector 3. The two adjacent antenna units 2 may be configured to be symmetrically arranged relative to the connector 3, and the connector 3 and the two connected reflecting plates 4 may be an integral piece, but is not limited thereto. For example, the connector 3 and the two connected reflecting plates 4 may be detachably connected by plugging, buckling, and the like. For a single antenna assembly 1, the antenna assembly 1 includes two antenna units 2, the two antenna units 2 are spaced apart in a second direction, and the reflecting plates 4 of the two antenna units 2 may both located in a second plane. The second plane is parallel to the first plane 9, the second direction is perpendicular to the first direction and parallel to the first plane 9, the number of antenna units 2 is not limited to two, and the antenna structure is described below by taking two as examples.

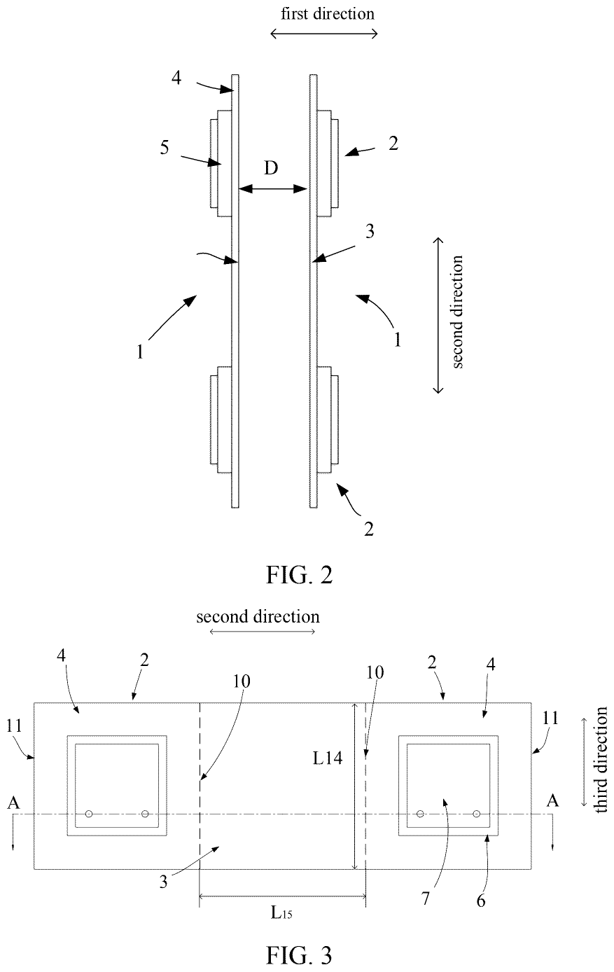

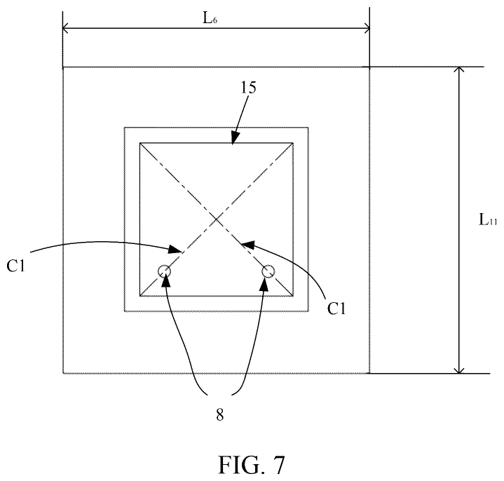

In some exemplary embodiments, as shown in FIGS. 1 and 3, the reflecting plate 4 may be made of metal, and the reflecting plate 4 may be provided as a square plate shape. In this example, the reflecting plate 4 may be a copper plate. A thickness of the reflecting plate 4 is h, and four peripheral edges of the reflecting plate 4 are perpendicular to each other and have a same extension length. As shown in FIG. 7, a dimension in the second direction is configured to be L₆, and a dimension in a third direction is configured to be L₁₁, wherein L₆=L₁₁. That is, a side length of a square projection of the reflecting plate 4 on the first plane is also L₆, and it can also be stated that the side length of the square projection of the reflecting plate 4 on the first plane is also L₁₁. A cross section of the reflecting plate 4 parallel to the first plane 9 is a square, and a side length of the square is also L₆ or L₁₁. The four peripheral edges of the reflecting plate 4 include a third edge 11 that is away from the connector 3, the third edge 11 extends in the third direction, and the third direction is perpendicular to the first direction and the second direction. The shape of the reflecting plate 4 is not limited to a square plate shape. For example, the reflecting plate 4 may also have a rectangular plate shape, and the dimension of the reflecting plate 4 in the second direction and the dimension of the reflecting plate 4 in the third direction are not equal to each other. For another example, the reflecting plate 4 has a diamond plate shape or the like, and the four peripheral edges of the reflecting plate 4 are no longer perpendicular to each other.

In some exemplary embodiments, as shown in FIGS. 1 and 3, the connector 3 may be made of metal and have a plate shape. In this example, the connector 3 may also be a copper plate, and the connector 3 may also be in the second plane, that is, the connector 3 and the reflecting plate 4 are coplanar. A plate thickness of the connector 3 may be the same as the thickness of the reflecting plate 4, both of which are h. In this way, the connector 3 and the two reflecting plates 4 can be formed by a copper plate having a thickness h, which helps for manufacturing. The connector 3 may be rectangular, and four peripheral edges of the connector may include two first edges 10 (dotted positions in FIG. 3) respectively located at both ends of the connector 3 in the second direction. An extension length of the first edges 10 is configured to be a dimension L₁₄ of the connector 3 in the third direction, the two first edges 10 are respectively connected to the two reflecting plates 4, and the first edges 10 extend in the third direction. Among the peripheral edges of the reflecting plate 4, the edge away from the third edge 11 is connected to the first edge 10, and the third edge 11 and the first edge 10 have a same extension length in the third direction. That is, L₁₄ as in FIG. 3 is equal to L₁₁ as in FIG. 7, so that both ends of the connector 3 and the reflecting plate 4 in the third direction are flush, and it can be seen that a copper plate forming the connector 3 and the two reflecting plates 4 is rectangular. Further, a dimension of the connector 3 in the second direction may be L₁₅, and the numerical value of L₁₅ is configured to be equal to the numerical value of L₁₄ so that the connector 3 is also a square, but not limited thereto. The dimension (L₁₅) of the connector 3 in the second direction may be larger or smaller than the dimension (L₁₄) of the connector in the third direction, forming a rectangular shape.

In some exemplary embodiments, as shown in FIGS. 1, 3, 5, and 7, the patch mechanism 5 may include a dielectric plate 6 and a radiation patch 7, the radiation patch 7 may be configured to be parallel to the reflecting plate 4 and spaced apart from the reflecting plate 4 in a first direction, and the dielectric plate 6 is sandwiched between the radiation patch 7 and the reflecting plate 4. The reflecting plate 4, the dielectric plate 6, and the radiation patch 7 may be integrally installed by a printed circuit board process, which is low-cost and easy to manufacture. With the use of the patch mechanism 5, the antenna structure is a microstrip patch antenna, which has the advantage of low profile and can effectively reduce the overall thickness of the antenna. The dielectric plate 6 may be a FR4 substrate, the radiation patch 7 may be a copper plate, and a distance between the two radiation patches 7 in the second direction is about 300 mm to 400 mm. Both the dielectric plate 6 and the radiation patch 7 are configured to be arranged centrally relative to the reflecting plate 4, geometric centers of the reflecting plate 4, the dielectric plate 6 and the radiation patch 7 are in a straight line and the straight line extends in the first direction.

In some exemplary embodiments, as shown in FIGS. 5 and 6, the dielectric plate 6 and the radiation patch 7 are also both square plate shape, four peripheral edges of the dielectric plate 6 are perpendicular to each other and have a same dimension, two edges extend in a second direction, and two edges extend in a third direction. A dimension of the dielectric plate 6 in the second direction is configured to be L₅, and a dimension of the dielectric plate 6 in the third direction is configured to be L₁₀, where the numerical value of L₅ is equal to the numerical value of L₁₀. A cross section of the dielectric plate 6 parallel to the first plane is square, and a side length of the square is L₅ or L₁₀, and the side length of the square extend along the second direction and the third direction, respectively. Four peripheral edges of the radiation patch 7 are perpendicular to each other, two edges extend in the second direction and two edges extend in the third direction. A dimension of the radiation patch 7 in the second direction is configured to be L₂, and a dimension of the radiation patch 7 in the third direction is configured to be L₉, where the numerical value of L₂ is equal to the numerical value of L₉. A cross section of the radiation patch 7 parallel to the first plane is a square having a side length of L₂, or L₉, and the side length of the square extend along the second direction and the third direction, respectively. Herein, an edge length of the dielectric plate 6 may be greater than an edge length of the radiation patch 7, and it can be seen that L₂=L₉<L₁₀=L₅. In combination with FIG. 7 on the basis of FIGS. 5 and 6, it can be seen that the edge length of the dielectric plate 6 can be greater than the edge length of the radiation patch 7 and that the edge length of the dielectric plate 6 can be smaller than an edge length of the reflecting plate 4, i.e. L₂=L₉<L₅=L₁₀<L₆=L₁₁. Areas of projections of the three square-shaped members on the first plane are, from small to large, those of the radiation patch 7, the dielectric plate 6 and the reflecting plate 4, such that the projection of the dielectric plate 6 on the first plane may be configured to be located in the projection of the reflecting plate 4 on the first plane, and the projection of the radiation patch 7 on the first plane may be located in the projection of the dielectric plate 6 on the first plane. A ratio of edge dimensions of the radiation patch 7 and the dielectric plate 6 is L₂:L₅, and the ratio value of L₂ to L₅ is between 1:1.33 and 1.07:1.12. A ratio of edge dimensions of the reflecting plate 4 and the dielectric plate 6 is L₆:L₅, and the ratio value of L₆:L₅ is between 1:2.1 and 1.19:1.39.

In some exemplary embodiments, as shown in FIGS. 1 and 3, a windward area of the antenna structure is about an area parallel to the first plane 9 of the copper plate forming the connector 3 and the two reflecting plates 4. An area of the cross section is equal to the product of a first side length and a second side length, the first side length is the dimension of the connector 3 and the two reflecting plates 4 in the second direction, and the second side length is the dimension of the connector 3 or the reflecting plate 4 in the third direction, and the windward area can be about between 0.1 m² and 0.15 m². In this example, the windward area may be 0.12 m², which is much less than a standard windward area (0.8 m²) for the antenna, compared to the standard windward area for the antenna. This ensures that the antenna structure has a relatively small windward area, and is less affected by the external environments such as wind and rain, reducing the risk of damage from the natural environment.

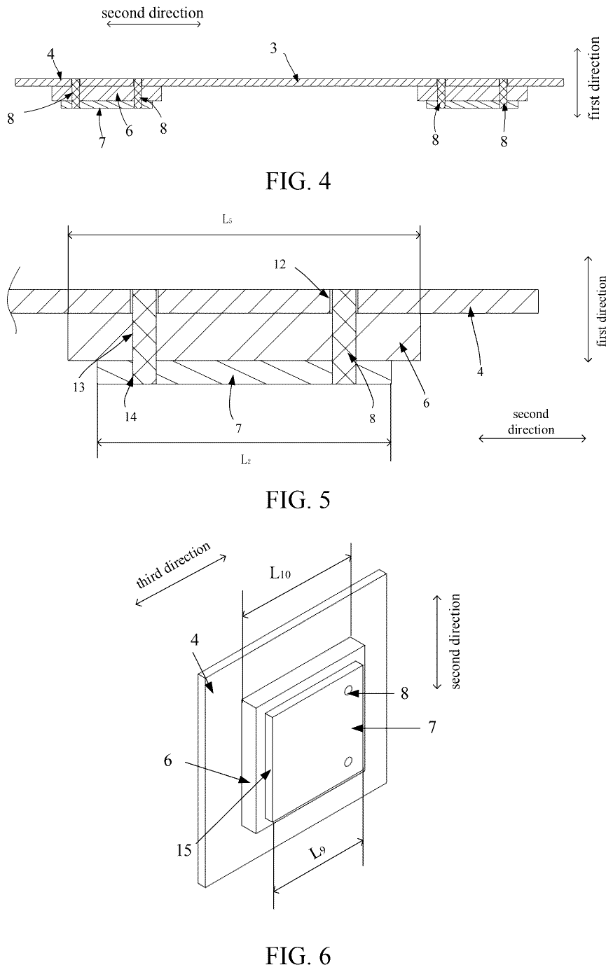

In some exemplary embodiments, as shown in FIGS. 3 to 7, the radiation patch 7 may have two feeding ports 8 rotationally symmetrical at 90° relative to a geometric center of the radiation patch 7, the feeding ports 8 may be coaxial feeding ports 8, and a phase difference between the two feeding ports 8 is 180°. The two feeding ports 8 are respectively located on the two diagonals C1 of the square radiation patch 7, forming ±45° dual-polarization, and the feeding mode is configured to be double-port equal amplitude and unequal phase feeding. The four peripheral edges of the radiation patch 7 include a second edge 15 at one end of the radiation patch 7 in the third direction, the second edge 15 extends in the second direction, and the two feeding ports 8 are configured to be arranged away from the second edge 15 and have a same distance from the second edge 15. The position of the two feeding ports 8 is not limited to this, for example, the two feeding ports 8 are respectively located on two diagonal C1, but both are arranged away from the other edges of the radiation patch 7. The feeding port 8 may be composed of a copper tin-plated pad (not shown in the figure) and a coaxial metal core (not shown in the figure), and the feeding port 8 has a circular cross section. The copper tin-plated pad is provided with a through hole (not shown in the figure) for accommodating the coaxial metal core. The coaxial metal core penetrates the radiation patch 7 and is welded to a front surface of the radiation patch 7 (an end surface facing away from the reflecting plate 4), and the other end of the coaxial metal core penetrates the reflecting plate 4 to be connected and may be connected to a power divider (not shown in the figure) by a cable. The reflecting plate 4, the dielectric plate 6 and the radiation patch 7 are sequentially provided with a first through hole 12, a second through hole 13 and a third through hole 14 that are to be penetrated by the feeding port 8.

In some exemplary embodiments, the antenna structure may include an insulating member (not shown in the figure) and a housing (not shown in the figure). The two antenna assemblies 1 are connected via the insulating member, and the insulating member may be a hexagonal nylon post. Holes need to be punched on the reflecting plate 4 or the connector 3 of the two antenna assemblies 1 respectively, and the insulating member correspondingly is inserted into the punched holes to form a fixed installation of the antenna assembly 1. The two antenna assemblies 1 may be mounted within the housing which is slightly larger than the dimension of the antenna structure, and the antenna structure may also be positioned within the housing by means of the insulating member.

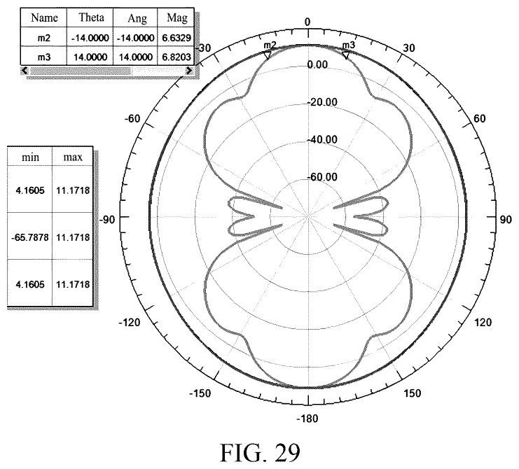

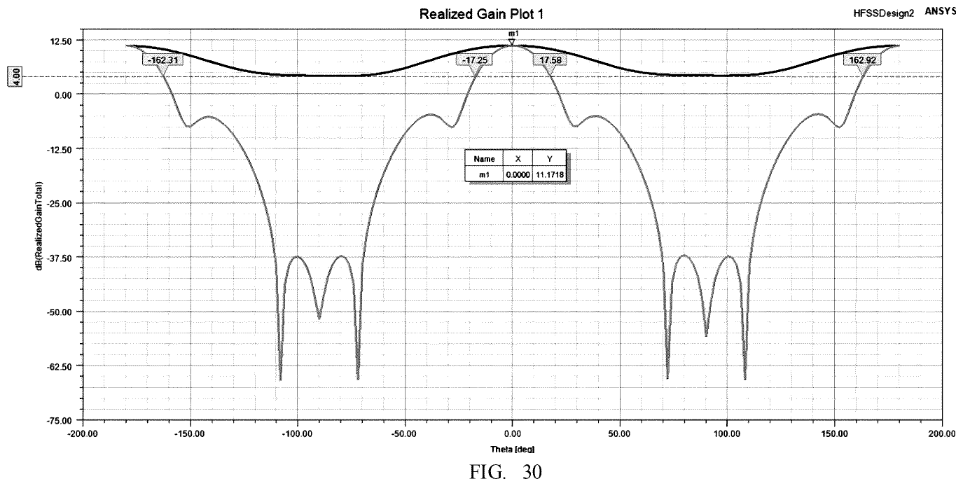

In some exemplary embodiments, FIG. 30 is a schematic diagram of Realizd Gain simulation of the antenna structure in FIG. 1 considering port loss, and FIG. 29 is an antenna pattern simulation of the antenna structure in FIG. 1. The Realizd Gain simulation refers to the ratio between input power and output power of the antenna, which considers matching loss and other factors. The abscissa axis in FIG. 30 is a circumferential angle of the antenna, and the ordinate is a numerical value of the gain. The antenna pattern refers to a pattern in which the relative field strength (normalized modulus value) of the radiated field changes with the direction at a certain distance from the antenna, and is usually represented by two mutually perpendicular plane patterns in the maximum radiation direction of the antenna. According to the data of FIGS. 29 and 30, the lowest gain of 360° omnidirectional coverage of the antenna structure with a distance D of 40 mm is 4.16 dB and the highest gain is 11.17 dB, and in the whole frequency band used, S11<−10 dB and S21<−20 dB, and the performance is excellent. Therefore, on the basis of ensuring performance, the antenna structure further simplifies the structure, reduces the occupied space, saves materials and reduces the cost.

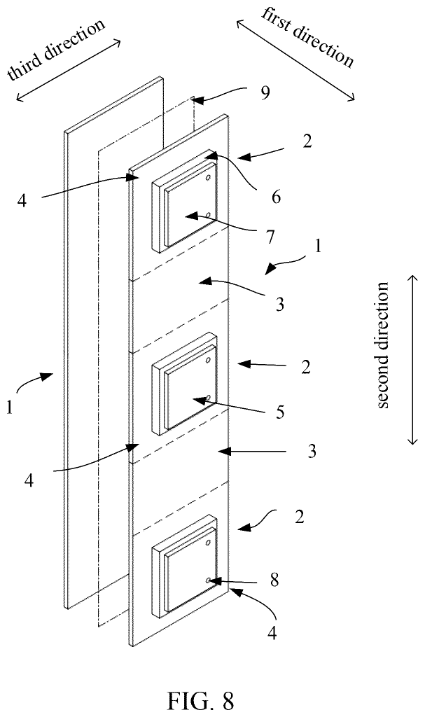

In some exemplary embodiments, as shown in FIG. 8, in terms of a single antenna assembly 1, the antenna assembly 1 includes three antenna units 2 arranged at intervals in a second direction, the reflecting plates 4 of the three antenna units 2 are all in a second plane that is parallel to the first plane 9, and the second direction is perpendicular to the first direction and parallel to the first plane 9. The reflecting plate 4 may have a square plate shape. In this example, the reflecting plate 4 and the connector 3 are both copper plates, and the connector 3 is also in the second plane, that is, the connector 3 and the reflecting plate 4 are coplanar. A plate thickness of the connector 3 may be the same as a thickness of the reflecting plate 4, so that the two connectors 3 and the three reflecting plates 4 are formed by a copper plate having a thickness h, which helps for manufacturing. The connector 3 is rectangular, a length of an edge of the connector 3 connected with reflecting plate 4 is consistent with a side length of the reflecting plate 4, and a copper plate forming the two connectors 3 and the three reflecting plates 4 is rectangular. The antenna unit 2 also includes a dielectric plate 6 and a radiation patch 7, and the reflecting plate 4, the dielectric plate 6 and the radiation patch 7 can be integrally installed by a PCB process, which is low-cost and easy to manufacture. The dielectric plate 6 may be a FR4 substrate, the radiation patch 7 may be a copper plate, and a distance between the two radiation patches 7 in the second direction are about 300 mm to 400 mm. Both the dielectric plate 6 and the radiation patch 7 are configured to be arranged centrally relative to the reflecting plate 4, and the dielectric plate 6 and the radiation patch 7 also have a square plate shape. Side lengths of the dielectric plate 6, the radiation patch 7 and the reflecting plate 4 are arranged in order from large to small as follows: the reflecting plate 4, the dielectric plate 6 and the radiation patch 7. The radiation patch 7 may have two feeding ports 8 rotationally symmetrical at 90° relative to a geometric center of the radiation patch 7, the feeding ports 8 may be coaxial feeding ports 8, and a phase difference between the two feeding ports 8 is 180°, forming ±45° dual-polarization. The feeding mode is configured to be double-port equal amplitude and unequal phase feeding. As shown in FIG. 8, a windward area of the antenna structure is about an area parallel to the first plane 9 of the copper plate forming the two connectors 3 and the three reflecting plates 4. In this example, the windward area is 0.2 m², which is much less than a standard windward area 0.8 m² for the antenna, compared to the standard windward area for the antenna. This ensures that the antenna structure has a relatively small windward area, reducing the risk of damage from the natural environment.

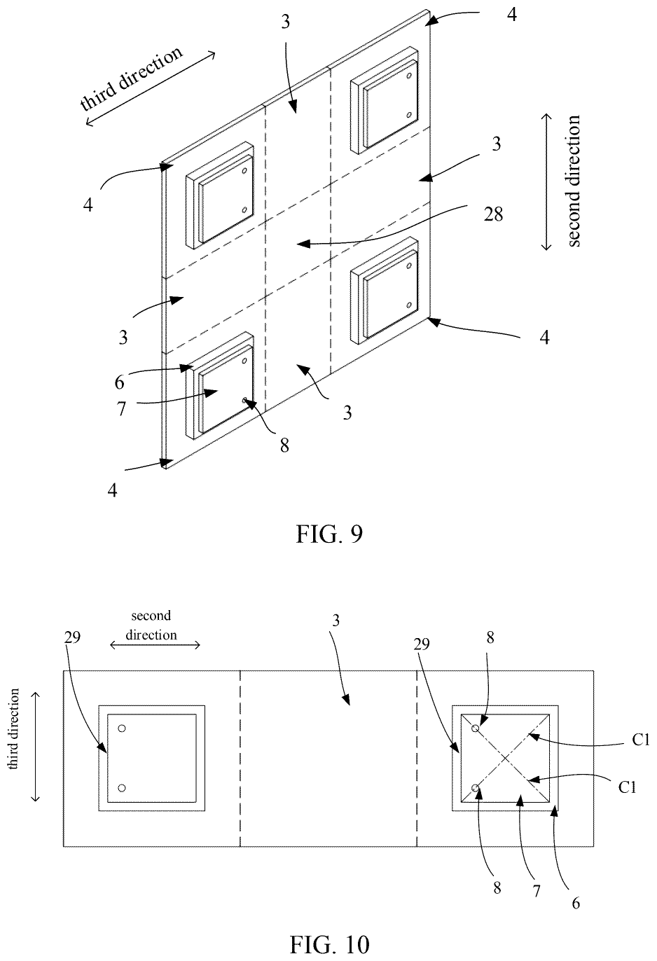

In some exemplary embodiments, as shown in FIG. 9, in terms of a single antenna assembly 1, the antenna assembly 1 includes four antenna units 2, and the reflecting plates 4 of the four antenna units 2 are all in a plane (second plane) formed by the second direction and the third direction, forming a structure of two rows and two columns. There are two columns of reflecting plates 4 spaced apart from each other in the third direction, and each column of reflecting plates 4 have two reflecting plates 4 spaced apart from each other. There are two rows of reflecting plates 4 spaced apart from each other in the second direction, and each row of reflecting plates 4 have two reflecting plates 4 spaced apart from each other. The distance between the two adjacent reflecting plates 4 is equal, whether in the third direction or in the second direction. The reflecting plate 4 may have a square plate shape. In this example, both the reflecting plate 4 and the connector 3 are copper plates. The connector 3 is also located in the second plane, that is, the four connectors 3 and the four reflecting plates 4 are coplanar. A region between the four connectors 3 is provided with a transition plate 28, which is also a copper plate. A plate thickness of the connector 3 and the transition plate 28 may be the same as a thickness of the reflecting plate 4, so that the four connectors 3, the four reflecting plates 4 and one transition plate 28 are formed by a copper plate having a thickness h, which helps for manufacturing. The connector 3 is rectangular, a length of an edge of the connector 3 connected with the reflecting plate 4 is consistent with a side length of the reflecting plate 4, and a copper plate forming the two connectors 3, the four reflecting plates 4 and the transition plate 28 is a square plate. The antenna unit 2 also includes a dielectric plate 6 and a radiation patch 7. The reflecting plate 4, the dielectric plate 6 and the radiation patch 7 can be integrally installed by a PCB process, which is low-cost and easy to manufacture. The dielectric plate 6 may be a FR4 substrate, the radiation patch 7 may be a copper plate, a distance between the two radiation patches 7 is about 300 mm to 400 mm, and a distance in the third direction is also about 300 mm to 400 mm. Both the dielectric plate 6 and the radiation patch 7 are configured to be arranged centrally relative to the reflecting plate 4, the dielectric plate 6 and the radiation patch 7 are also have a square plate shape, and side lengths of the dielectric plate 6, the radiation patch 7 and the reflecting plate 4 are arranged in order from large to small as follows: the reflecting plate 4, the dielectric plate 6 and the radiation patch 7. The radiation patch 7 may have two feeding ports 8 rotationally symmetrical at 90 ° relative to a geometric center of the radiation patch 7, the feeding ports 8 may be coaxial feeding ports 8, and a phase difference between the two feeding ports 8 is 180°, forming ±45° dual-polarization. The feeding mode is configured to be double-port equal amplitude and unequal phase feeding. As shown in FIG. 9, a windward area of the antenna structure is about an area parallel to the first plane of the copper plate forming the four connectors 3, the four reflecting plates 4, and one transition plate 28. In this example, the windward area is 0.3 m², which is also much smaller than a standard windward area 0.8 m² for the antenna, compared to the standard windward area for the antenna. This ensures that the antenna structure has a relatively small windward area, reducing the risk of damage from the natural environment.

In some exemplary embodiments, as shown in FIG. 10, in terms of one antenna unit 2, it includes a reflecting plate 4, a dielectric plate 6 and a radiation patch 7 that are square. The reflecting plate 4, the dielectric plate 6 and the radiation patch 7 can be integrally installed by a PCB process, which is low-cost and easy to manufacture. The dielectric plate 6 and the radiation patch 7 are both configured to be arranged centrally relative to the reflecting plate 4. The two feeding ports 8 are respectively located on the two diagonals C1 of the square radiation patch 7, forming ±45° dual-polarization, and the feeding mode is configured to be double-port equal amplitude and unequal phase feeding. The four peripheral edges of the radiation patch 7 include a fourth edge 29 at one end of the radiation patch 7 in the second direction, the fourth edge 29 extends in the third direction, and the two feeding ports 8 are configured to be close to the fourth edge 29 and have a same distance from the fourth edge 29.

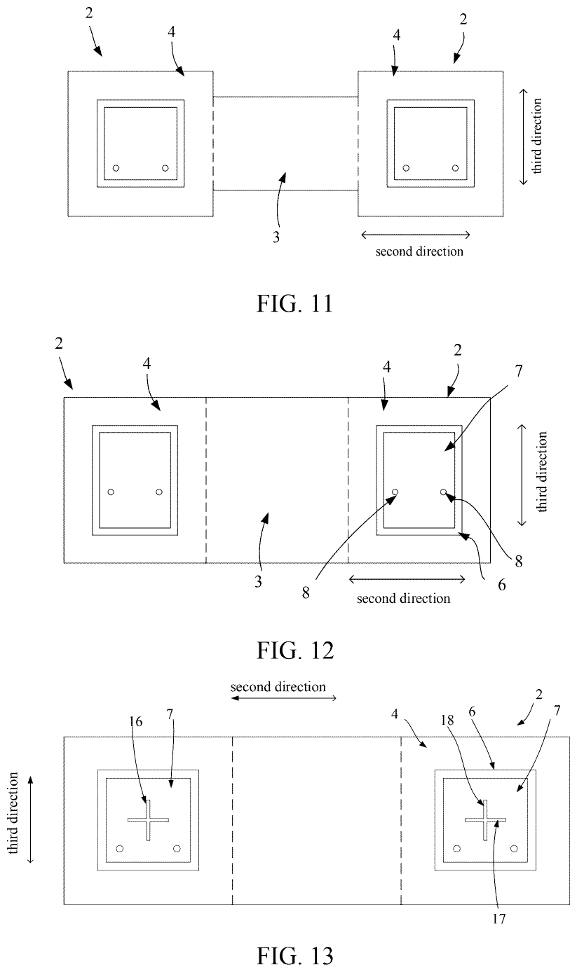

In some exemplary embodiments, as shown in FIG. 11, in terms of a single antenna assembly 1, the antenna assembly 1 includes two antenna units 2, the two antenna units 2 are spaced apart in the second direction, and the reflecting plates 4 of the two antenna units 2 are located in one plane. The reflecting plate 4 may have a square plate shape. In this example, the reflecting plate 4 and the connector 3 are both copper plates, and the connector 3 is also located in the second plane, that is, the connector 3 and the reflecting plate 4 are coplanar. A plate thickness of the connector 3 may be the same as a thickness of the reflecting plate 4, so that the one connector 3 and the two reflecting plates 4 are formed by a copper plate having a thickness h, which helps for manufacturing. The connector 3 is rectangular, a dimension of the connector 3 in the third direction is smaller than a dimension of the reflecting plate 4 in the third direction, and the connector 3 is arranged centrally in the third direction. A copper plate forming two connectors 3 and three reflecting plates 4 is “I”-shaped. The dielectric plate 6 may be a FR4 substrate, the radiation patch 7 may be a copper plate, and a distance between the two radiation patches 7 in the second direction are about 300 mm to 400 mm. Both the dielectric plate 6 and the radiation patch 7 are configured to be arranged centrally relative to the reflecting plate 4, the dielectric plate 6 and the radiation patch 7 are also have a square plate shape, and side lengths of the dielectric plate 6, the radiation patch 7 and the reflecting plate 4 are arranged in order from large to small as follows: the reflecting plate 4, the dielectric plate 6 and the radiation patch 7. The radiation patch 7 may have two feeding ports 8 rotationally symmetrical at 90° relative to a geometric center of the radiation patch 7, the feeding ports 8 may be coaxial feeding ports 8, and a phase difference between the two feeding ports 8 is 180°, forming ±45° dual polarization. The feeding mode is configured to be double-port equal amplitude and unequal phase feeding. As shown in FIG. 11, a windward area of the antenna structure is about an area parallel to the first plane 9 of a copper plate forming one connector 3 and the two reflecting plates 4. In this example, the windward area is smaller, about 0.1 m², which is also much smaller than a standard windward area of 0.8 m² for the antenna, compared to the standard windward area for the antenna. This ensures that the antenna structure has a relatively small windward area, reducing the risk of damage from the natural environment. The reflecting plate 4, the dielectric plate 6, and the radiation patch 7 may be integrally installed by a printed circuit board process, which is low-cost and easy to manufacture.

In some exemplary embodiments, as shown in FIG. 12, in terms of a single antenna assembly 1, the antenna assembly 1 includes a reflecting plate 4, a dielectric plate 6, and a radiation patch 7, which are also all rectangular. Dimensions of the reflecting plate 4, the dielectric plate 6, and the radiation patch 7 in the third direction are all larger than respective dimensions in the second direction, but are not limited thereto. For example, the dimensions of the reflecting plate 4, the dielectric plate 6, and the radiation patch 7 in the second direction are all larger than the respective dimensions in the third direction. The dimension of the connector 3 in the third direction is the same as the dimension of the reflecting plate 4 in the third direction, so that the connector 3 and two reflecting plates 4 form one copper plate. Both the dielectric plate 6 and the radiation patch 7 are arranged centrally relative to the reflecting plate 4, such that the dielectric plate 6 on one reflecting plate 4 is symmetrical to the dielectric plate 6 on the other reflecting plate 4 relative to the connector 3, and the radiation patch 7 on one reflecting plate 4 is symmetrical to the radiation patch 7 on the other reflecting plate 4 relative to the connector 3. The radiation patch 7 may have two feeding ports 8 rotationally symmetrical at 90° relative to a geometric center of the radiation patch 7, the feeding ports 8 may be coaxial feeding ports 8, and a phase difference between the two feeding ports 8 is 180°, forming ±45° dual-polarization. The feeding mode is configured to be double-port equal amplitude and unequal phase feeding.

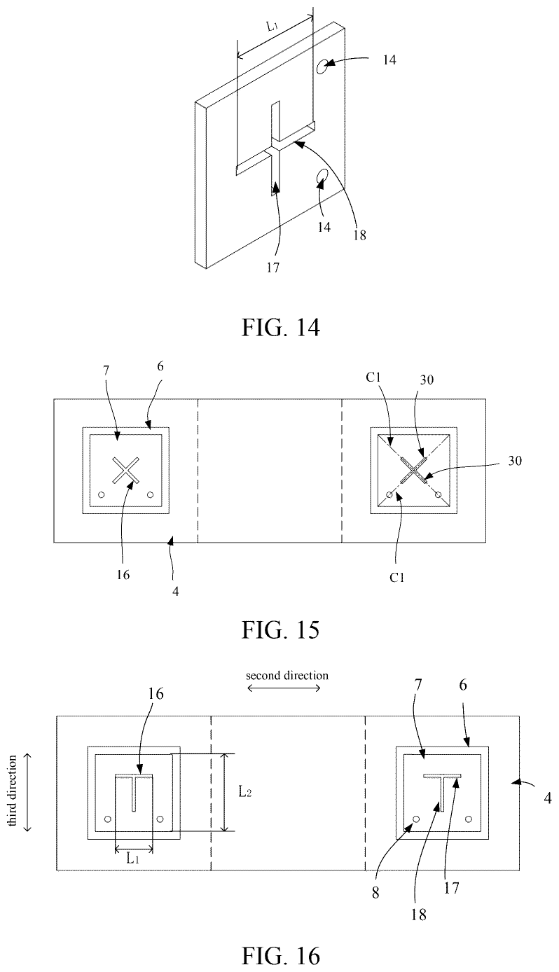

In some exemplary embodiments, as shown in FIGS. 13 and 14, in terms of one antenna unit 2, it includes a reflecting plate 4, a dielectric plate 6 and a radiation patch 7 that are square. The reflecting plate 4, the dielectric plate 6 and the radiation patch 7 can be integrally installed by a PCB process, which is low-cost and easy to manufacture. The dielectric plate 6 and the radiation patch 7 are both configured to be arranged centrally relative to the reflecting plate 4. The two feeding ports 8 are located on two diagonals of the square radiation patch 7, respectively. The radiation patch 7 may be provided with a second slot 16 arranged centrally on the radiation patch 7 and penetrating the radiation patch 7 in a thickness direction of the radiation patch 7. A geometric center of the second slot 16 coincides with a geometric center of the radiation patch 7 to achieve a centered arrangement. The second slot 16 is provided as a cross-shaped slot, the cross-shaped slot includes a second transverse slot 17 and a second vertical slot 18 that intersect, the second transverse slot 17 and the second vertical slot 18 are perpendicular to each other, and the second transverse slot 17 and the second vertical slot 18 have a same slot length, which is L₁. The second transverse slot 17 and the second vertical slot 18 have a same slot width, which is between 1 mm and 2 mm. A slot depth of the second transverse slot 17 and the second vertical slot 18 is a plate thickness of the radiation patch 7, so as to realize penetration of the radiation patch 7. As shown in FIG. 5, the radiation patch 7 is a square plate with a side length of L₂, that is, an extension length of the radiation patch 7 in the second direction is configured to be L₂, and combined with that shown in FIG. 14, L₁:L₂=1:2, and the slot lengths of the second transverse slot 17 and the second vertical slot 18 are about half of the dimension of the side length of the radiation patch 7. In the antenna structure of this example, by providing the second slot 16, the current distribution on the antenna is changed, and the length of the current path is increased, so that the antenna generates a resonance point with a resonant frequency lower than that of the antenna structure shown in FIG. 1, thereby expanding the bandwidth of the antenna. The second slot 16 is not limited to being a cross-shaped slot, and may be, for example, L-shaped or the like, but it is necessary to be arranged centrally on the radiation patch 7.

In some exemplary embodiments, as shown in FIG. 15, an antenna unit includes a reflecting plate 4, a dielectric plate 6 and a radiation patch 7 that are square. The reflecting plate 4, the dielectric plate 6 and the radiation patch 7 can be integrally installed by a PCB process, which is low-cost and easy to manufacture. The dielectric plate 6 and the radiation patch 7 are both configured to be arranged centrally relative to the reflecting plate 4. The radiation patch 7 may be provided with a second slot 16 arranged centrally on the radiation patch 7 and penetrating the radiation patch 7 in a thickness direction of the radiation patch 7. A geometric center of the second slot 16 coincides with a geometric center of the radiation patch 7 to achieve a centered arrangement. The second slot 16 is provided as a cross-shaped slot, the cross-shaped slot includes two inclined slots 30 that intersect, and the two inclined slots 30 are perpendicular to each other. The two inclined slots 30 have a same slot length and a same slot width, the slot width can be set between 1 mm and 2 mm, and a slot depth of the two inclined slots 30 is a plate thickness of the radiation patch 7, so as to realize penetration of the radiation patch 7. The radiation patch 7 may have two feeding ports 8 rotationally symmetrical at 90° relative to a geometric center of the radiation patch 7, the feeding ports 8 may be coaxial feeding ports 8, a phase difference between the two feeding ports 8 is 180°, forming ±45° dual polarization. The feeding mode is configured to be double-port equal amplitude and unequal phase feeding. As shown in FIG. 15, the radiation patch 7 is a square plate, the slot length of the inclined slot 30 is about half of the dimension of the side length of the radiation patch 7, one inclined slot 30 and one feeding port 8 are located on one diagonal C1 of the radiation patch 7, and the other inclined slot 30 and the other feeding port 8 are located on the other diagonal C1 of the radiation patch 7. In the antenna structure of this example, by providing the second slot 16, the current distribution on the antenna is changed, and the length of the current path is increased, so that the antenna generates a resonance point with a resonant frequency lower than that of the antenna structure shown as FIG. 1 (the antenna structure shown in FIG. 1 is not provided with the second slot 16), thereby expanding the bandwidth of the antenna.

In some exemplary embodiments, as shown in FIG. 16, an antenna unit may include a reflecting plate 4, a dielectric plate 6 and a radiation patch 7 that are square. The reflecting plate 4, the dielectric plate 6 and the radiation patch 7 can be integrally installed by a printed circuit board process, which is low-cost and easy to manufacture. The dielectric plate 6 and the radiation patch 7 are both configured to be arranged centrally relative to the reflecting plate 4. The radiation patch 7 may be provided with a second slot 16 arranged centrally on the radiation patch 7 and penetrating the radiation patch 7 in a thickness direction of the radiation patch 7. A geometric center of the second slot 16 coincides with a geometric center of the radiation patch 7 to achieve a centered arrangement. The second slot 16 is provided as a T-shaped slot, the T-shaped slot includes a second transverse slot 17 and a second vertical slot 18 that intersect, the second transverse slot 17 and the second vertical slot 18 are perpendicular to each other, and the second transverse slot 17 and the second vertical slot 18 have a same slot length, which is L₁. The second transverse slot 17 and the second vertical slot 18 have a same slot width, which is set between 1 mm and 2 mm. A slot depth of the second transverse slot 17 and the second vertical slot 18 is a plate thickness of the radiation patch 7, so as to realize penetration of the radiation patch 7. One end of the second vertical slot 18 is connected to the second transverse slot 17 to form a T-shape, and a geometric center of the T-shaped slot is located on the geometric center of the radiation patch 7. As shown in FIG. 16, the radiation patch 7 is a square plate with a side length of L₂, that is, an extension length of the radiation patch 7 in the third direction is configured to be L₂, and combined with that shown in FIG. 16, L₁:L₂=1:2, and the slot length of the second transverse slot 17 and the second vertical slot 18 is about half of the dimension of the side length of the radiation patch 7. In the antenna structure of this example, by providing the second slot 16, the current distribution on the antenna is changed, and the length of the current path is increased, so that the antenna generates a resonance point with a resonant frequency lower than that of the antenna structure shown in FIG. 1, thereby expanding the bandwidth of the antenna. The second slot 16 is not limited to being a T-shaped slot, and may be, for example, “I”-shaped or the like, but it is necessary to be arranged centrally on the radiation patch 7.

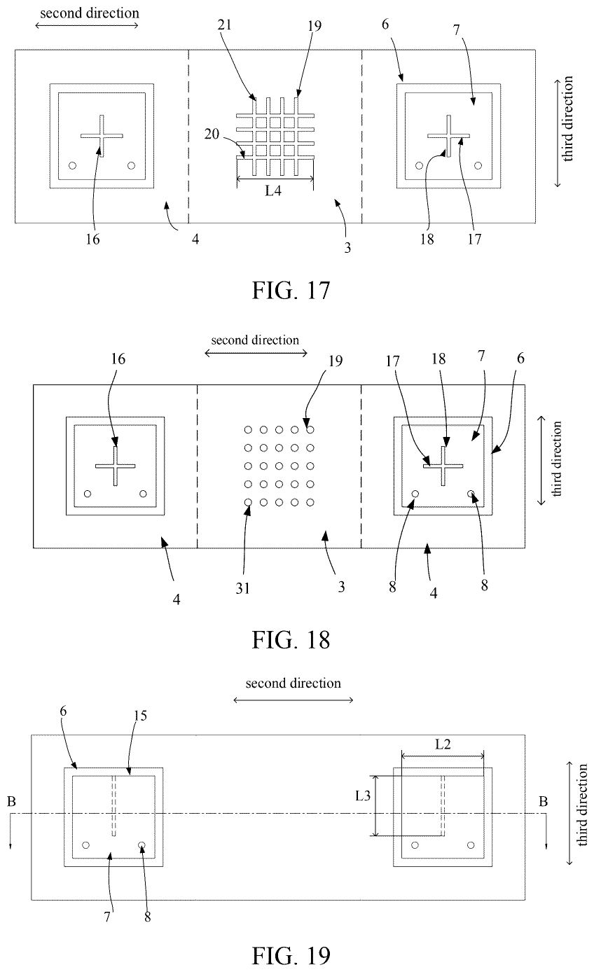

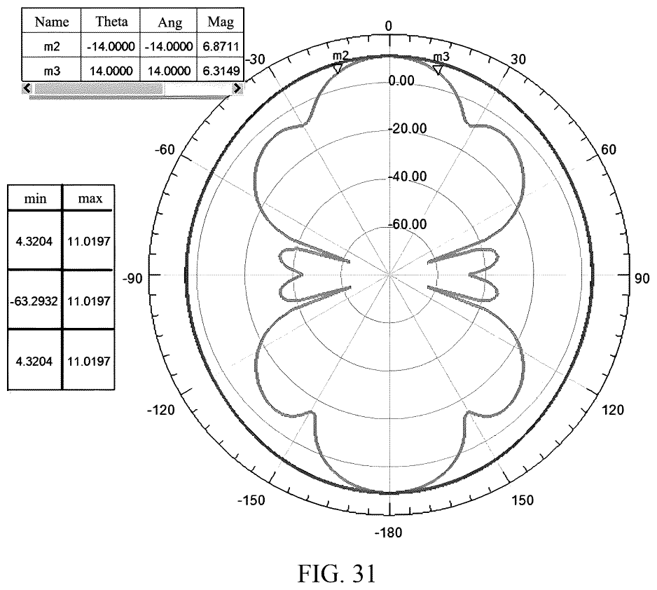

In some exemplary embodiments, as shown in FIG. 17, an antenna unit includes a reflecting plate 4, a dielectric plate 6 and a radiation patch 7 that are square. The reflecting plate 4, the dielectric plate 6 and the radiation patch 7 can be integrally installed by a PCB process, which is low-cost and easy to manufacture. The dielectric plate 6 and the radiation patch 7 are both configured to be arranged centrally relative to the reflecting plate 4. Both the radiation patch 7 and the connector 3 have slots, and the radiation patch 7 may be provided with a second slot 16 arranged centrally on the radiation patch 7 and penetrating the radiation patch 7 in a thickness direction of the radiation patch 7. A geometric center of the second slot 16 coincides with a geometric center of the radiation patch 7 to achieve a centered arrangement. The second slot 16 is provided as a cross-shaped slot, the cross-shaped slot includes a second transverse slot 17 and a second vertical slot 18 that intersect, and the second transverse slot 17 and the second vertical slot 18 are perpendicular to each other. The connector 3 may be provided with a first slot 19 configured to penetrate the connector 3 in a first direction, and the first slot 19 is arranged centrally on the connector 3 and is symmetrical relative to a geometric center of the connector 3. The symmetry of the antenna would be affected if the first slot 19 is arranged eccentrically. The first slot 19 includes first transverse slots 20 and first vertical slots 21 that intersect. A plurality of first transverse slots 20 are parallel to each other and arranged at equal intervals in the second direction, and a plurality of first vertical slots 21 are parallel to each other and arranged at equal intervals in the third direction. The first transverse slots 20 are perpendicular to the first vertical slots 21. Each of the first transverse slots 20 may be configured to cross-communicate with all of the first vertical slots 21, and each of the first vertical slots 21 may be configured to cross-communicate with all of the first transverse slots 20, to form a mesh shape. The first transverse slots 20 and the first vertical slot 21 have a same slot length L₄ that is smaller than the side length of the dielectric plate, wherein L₄ is about 0.9×L₅. Both the first transverse slots 20 and the first vertical slot 21 have a same slot depth and a same slot width, wherein the slot width is 1 mm to 1.5 mm. In this example, the slot width is 1 mm, and the slot depth of both slots is a plate thickness of the connector 3. The dielectric plate 6 may be a FR4 substrate, the radiation patch 7 and the reflecting plate 4 may be a copper plate, and a distance between the two radiation patches 7 in the second direction are about 300 mm to 400 mm. The dielectric plate 6 and the radiation patch 7 are also have a square plate shape, and the side lengths of the dielectric plate 6, the radiation patch 7 and the reflecting plate 4 are arranged in order from larger to smaller as follows: the reflecting plate 4, the dielectric plate 6 and the radiation patch 7. The radiation patch 7 may have two feeding ports 8 rotationally symmetrical at 90° relative to a geometric center of the radiation patch 7, the feeding ports 8 may be coaxial feeding ports 8, a phase difference between the two feeding ports 8 is 180°, forming ±45° dual polarization. The feeding mode is configured to be double-port equal amplitude and unequal phase feeding. In the antenna structure of the present example, by adding the first slot 19, the coupling effect between the antenna assemblies 1 on both sides can be improved. FIG. 31 is a schematic diagram of antenna pattern simulation of the antenna structure. As shown in FIGS. 31 and 29, compared with the antenna structure described in FIG. 1, the lowest gain of the antenna structure is increased from 4.16 dB to 4.3 dB, and the highest gain is reduced from 11.17 dB to 11.02 dB, and the non-roundness of the overall pattern is increased by about 0.3 dB. The first slot 19 is not limited to the first transverse slot 20 and the first vertical slot 21 that intersect. For example, the first slot 19 may be only a plurality of first transverse slots 20 that are parallel, or for example, only a plurality of first vertical slots 21 that are parallel, and the path of the current may be increased and the coupling may be reduced.

In some exemplary embodiments, as shown in FIG. 18, an antenna unit includes a reflecting plate 4, a dielectric plate 6 and a radiation patch 7 that are square. The reflecting plate 4, the dielectric plate 6 and the radiation patch 7 can be integrally installed by a PCB process, which is low-cost and easy to manufacture. The dielectric plate 6 and the radiation patch 7 are both configured to be arranged centrally relative to the reflecting plate 4. Both the radiation patch 7 and the connector 3 have slots, the radiation patch 7 may be provided with a second slot 16 arranged centrally on the radiation patch 7 and penetrating the radiation patch 7 in a thickness direction of the radiation patch 7. A geometric center of the second slot 16 coincides with a geometric center of the radiation patch 7 to achieve a centered arrangement. The second slot 16 is provided as a cross-shaped slot, the cross-shaped slot includes a second transverse slot 17 and a second vertical slot 18 that intersect, and the second transverse slot 17 and the second vertical slot 18 are perpendicular to each other. The connector 3 may be provided with a first slot 19 configured to penetrate the connector 3 in a first direction, and the first slot 19 is arranged centrally on the connector 3 and is symmetrical relative to a geometric center of the connector 3. The symmetry of the antenna would be affected if the first slot 19 is arranged eccentrically. The first slot 19 includes a plurality of circular vias 31, and the plurality of circular vias 31 are arranged in a matrix. In this example, the circular vias 31 constitute a 5×5 array. There are five columns of circular vias 31 in the second direction, the circular vias 31 in each column are arranged at equal intervals, and each column of circular vias 31 has five circular vias 31. In the third direction, there are five rows of circular vias 31, the circular vias 31 in each row is arranged at equal intervals, and each row of circular vias 31 has five circular vias 31. The first slot 19 is not limited to the circular vias 31, and may be square holes, diamond holes, or the like, and the arrangement of the circular vias 31 may form another array structure. In the antenna structure of the present example, by adding the first slot 19, the coupling effect between the antenna assemblies 1 on both sides can be improved.

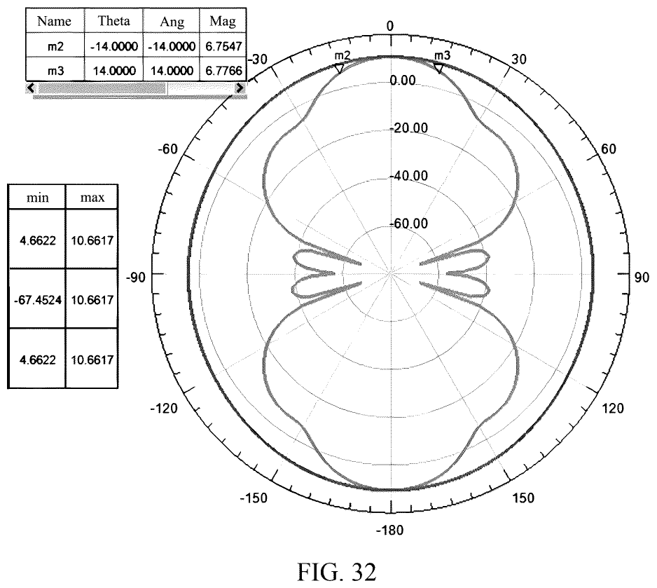

In some exemplary embodiments, two antenna assemblies as shown in FIG. 2 are adopted, the distance between the two antenna assemblies is D, and the numerical value of D is configured to be 30 mm, which reduces the distance between the two antenna assemblies, and is beneficial to further improve the coupling effect between the antenna assemblies on both sides. FIG. 32 is an antenna pattern of the antenna structure of FIG. 1 with a distance of 30 mm, and FIG. 29 is an antenna pattern of the antenna structure of FIG. 1 with a distance of 40 mm. As shown in FIGS. 32 and 29, an antenna pattern simulation has made to the antenna structure. Compared with the antenna structure of D=40 mm, the lowest gain of the antenna structure of this example is increased from 4.3 dB to 4.6 dB, and the highest gain is reduced from 11.02 dB to 10.66 dB. The non-roundness of the overall pattern is increased again by 0.66 d. In addition, reducing the spacing between the two antenna assemblies can also effectively reduce the overall volume of the antenna structure, which is more conducive to catering to the trend of miniaturization and high gain products.

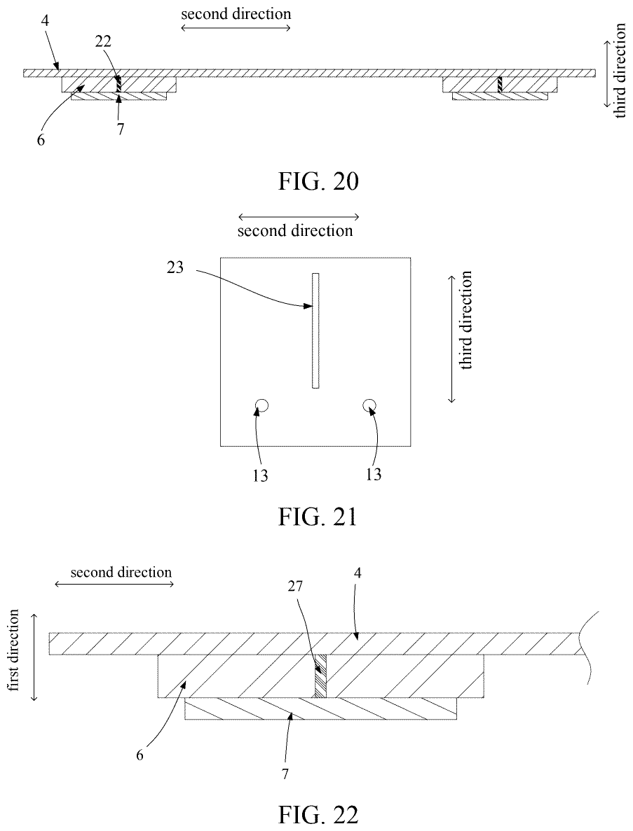

In some exemplary embodiments, as shown in FIGS. 19 to 22, an antenna unit includes a reflecting plate 4, a dielectric plate 6 and a radiation patch 7 that are square. The reflecting plate 4, the dielectric plate 6, and the radiation patch 7 are connected in turn. The reflecting plate 4, the dielectric plate 6 and the radiation patch 7 can be integrally installed by a PCB process, which is low-cost and easy to manufacture. The dielectric plate 6 and the radiation patch 7 are both configured to be arranged centrally relative to the reflecting plate 4. A metal member 22 may be provided between the radiation patch 7 and the reflecting plate 4, and the radiation patch 7 and the reflecting plate 4 may be arranged to be electrically connected via the metal member 22, and the metal member 22 is embedded into the dielectric plate 6. The metal member 22 may be provided as a metal sheet 27, which may be a thin metal sheet, also processed in the dielectric plate 6 by a printed circuit board process. The metal sheet 27 is perpendicular to the reflecting plate 4 and the radiation patch 7 and is attached to the reflecting plate 4 and the radiation patch 7 at both ends in the first direction. The dielectric plate 6 is provided with an embedding slot 23 for receiving the metal sheet 27, and the embedding slot 23 penetrates the dielectric plate 6 in the first direction and is arranged in a slot shape and size corresponding to an outer contour of the metal sheet 27. The metal member 22 extends in a third direction and is arranged centrally relative to the radiation patch 7 in a second direction. One edge of the radiation patch 7 in the third direction is provided as a second edge 15, and both feeding ports 8 are away from the second edge 15. One end of the metal sheet 27 is flush with the second edge 15, and the other end of the metal sheet 27 extends toward a side of the radiation patch 7 having the feeding ports 8. A length of the metal sheet 27 in the third direction may be configured to be L₃, and a dimension of a side length of the radiation patch 7 is L₂, i.e. an extension length of the radiation patch 7 in the second direction is configured to be L₂, wherein the ratio of L₃ to L₂ is between 1:4.8 and 1:4.5. In this example, providing the metal member 22 can improve isolation between the two feeding ports 8 and reduce interference. The metal member 22 is not limited to the metal sheet 27, for example, it can also be replaced with metallized vias (not shown in the figure), and a plurality of metallized vias are provided. The plurality of metallized vias are configured to be arranged in a straight line along the third direction. The metallized vias are a common processing means of PCB processing technology, involving opening holes in the dielectric plate and metallizing the hole walls.

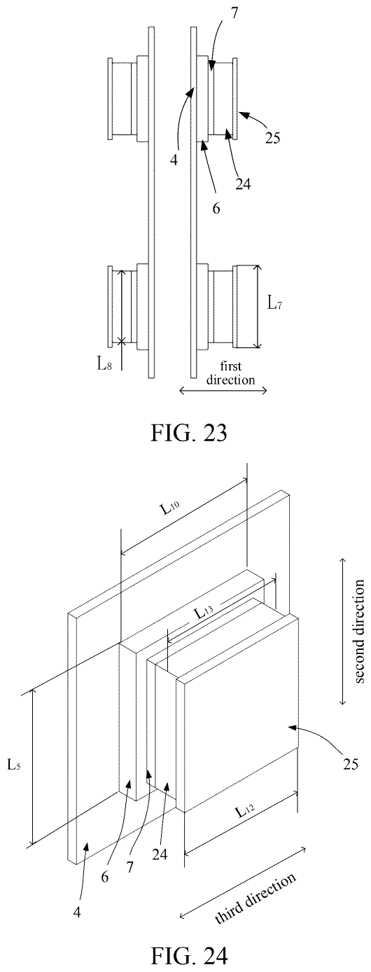

In some exemplary embodiments, as shown in FIGS. 23 and 24, the antenna unit includes a reflecting plate 4 and a patch mechanism 5 that are square. The patch mechanism 5 includes a dielectric plate 6, a radiation patch 7, a parasitic patch 25 and a foam pad 24. The reflecting plate 4, the dielectric plate 6, the radiation patch 7, the parasitic patch 25 and the foam pad 24 are connected in turn. The reflecting plate 4, the dielectric plate 6 and the radiation patch 7 can be integrally installed by a PCB process, which is low-cost and easy to manufacture. The dielectric plate 6, the radiation patch 7, the parasitic patch 25 and the foam pad 24 are configured to be arranged centrally relative to the reflecting plate 4. This parasitic patch 25 is located on a side of the radiation patch 7 facing away from the reflecting plate 4, said parasitic patch 25 is disposed parallel to the radiation patch 7 and spaced apart from the radiation patch 7 in a first direction, and the foam pad 24 is sandwiched between the parasitic patch 25 and the radiation patch 7. The parasitic patch 25 and the foam pad 24, as well as the radiation patch 7 and the foam pad 24 are joined by adhesive bonding, but are not limited thereto. For example, a hexagonal nylon post can be used for locking and fixing. The parasitic patch 25 is a square plate, four peripheral edges of the parasitic patch 25 are perpendicular and equal to each other, two edges are arranged in the second direction and two edges are arranged in the third direction. A dimension of the parasitic patch 25 in the second direction is configured to be L₇, and a dimension of the parasitic patch 25 in the third direction is configured to be L₁₂. The numerical value of Ly is equal to the numerical value of L₁₂. The foam pad 24 is a square plate, four peripheral edges of the foam pad 24 are perpendicular and equal to each other, two edges are arranged in the second direction and two edges are arranged in the third direction. A dimension of the foam pad 24 in the second direction is configured to be L₈, and a dimension of the foam pad 24 in the third direction is configured to be L₁₃. The numerical value of L₈ is equal to the numerical value of L₁₃. Meanwhile, the dimensions of the parasitic patch 25 in both the second direction and the third direction are larger than the corresponding lengths of the radiation patch 7 in the second direction and the third direction, that is, the numerical values of L₇ and L₁₂ shown in FIGS. 23 and 24 are larger than the numerical values of L₂ and L₉ of the radiation patch 7 as shown in FIGS. 5 and 6. The dimensions of the parasitic patch 25 in both the second direction and the third direction are smaller than the corresponding lengths of the dielectric plate 6 in the second direction and the third direction, that is, the numerical values of L₇ and L₁₂ in FIGS. 23 and 24 are larger than the numerical values of L₅ and L₁₀ of the dielectric plate 6 as shown in FIG. 23. In addition, the dimensions of the foam pad 24 in both the second direction and the third direction are equal to the corresponding lengths of the dielectric plate 6 in the second direction and the third direction, that is, the numerical values of L₇ and L₁₂ shown in FIGS. 23 and 24 are equal to the corresponding lengths of the radiation patch 7 as shown in FIG. 23 in the second direction and the third direction. Geometric centers of the radiation patch 7, the parasitic patch 25 and the foam pad 24 are located on a straight line extending in a first direction, forming a centralized arrangement of the parasitic patch 25 and the foam pad 24 relative to the radiation patch 7. A projection of the radiation patch 7 on the first plane is located in a projection range of the parasitic patch 25 on the first plane, and a projection of the foam pad 24 on the first plane is the same as the projection of the radiation patch 7 on the first plane. The parasitic patch 25 is a copper sheet, and the foam pad 24 is made of foam material with a thickness of about 18 mm to 32 mm. At the same time, a dielectric constant of the foam pad 24 is close to that of air, which is an ideal material close to air simulation. In the antenna structure of this example, the parasitic patch 25 and the foam pad 24 are added, and a new resonance point can be added, so that the bandwidth can be effectively increased.

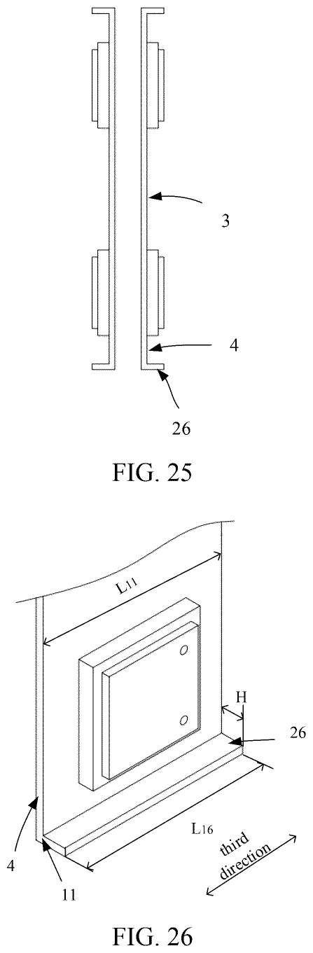

In some exemplary embodiments, as shown in FIGS. 25 and 26, the reflecting plate 4 is provided with a reflecting sheet 26 perpendicular to the reflecting plate 4, the reflecting sheet 26 and the reflecting plate 4 are provided as an integral piece, and the reflecting plate 4 is formed by bending a plate material of the reflecting sheet 26. An edge of the reflecting plate 4 away from the connector 3 is provided as a third edge 11, one end of the reflecting sheet 26 is connected to the third edge 11 and the other end of the reflecting sheet 26 extends away from the reflecting plate 4, and the reflecting sheet 26 can be perpendicular to the reflecting plate 4. A length of the reflecting sheet 26 may be configured to be the same as an extension length of the third edge 11 to facilitate processing, and the length of the reflecting sheet 26 is configured to be L₁₆, and the extension length of the third edge 11 is the same as a dimension L₁₁ of the reflecting sheet 26 in the third direction. The numerical value of L₁₆ is equal to the numerical value of L₁₁. A distance between one end of the reflecting sheet 26 away from the reflecting plate 4 and the reflecting plate 4 is H, where 10 mm<H<15 mm. The antenna structure of the present example is provided with a reflecting sheet 26, and the reflecting sheet 26 can concentrate the beam reflection, so that some escape energy can be reflected back to a main direction through the reflecting sheet 26 to form an effect of beam superposition, thereby improving the gain, and improving the antenna performance without increasing the antenna profile.

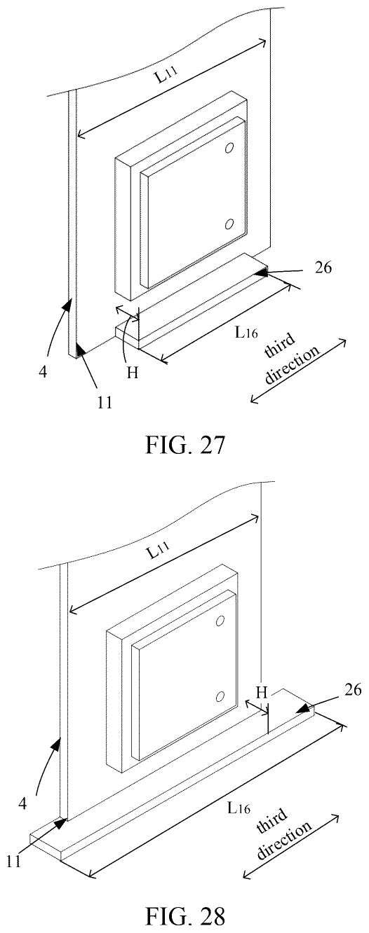

In some exemplary embodiments, as shown in FIG. 27, the reflecting plate 4 is provided with a reflecting sheet 26 perpendicular to the reflecting plate 4, the reflecting sheet 26 and the reflecting plate 4 are provided as an integral piece, and the reflecting plate 4 is formed by bending a plate material of the reflecting sheet 26. The reflecting plate 4 is provided with a third edge 11, one end of the reflecting sheet 26 is connected to the third edge 11 and the other end of the reflecting sheet 26 extends away from the reflecting plate 4, and the reflecting sheet 26 can be perpendicular to the reflecting plate 4. A length of the reflecting sheet 26 may be configured to be inconsistent with an extension length of the third edge 11. The length of the reflecting sheet 26 is configured to be L₁₆, and the extension length of the third edge 11 is the same as a dimension L₁₁ of the reflecting sheet 26 in the third direction. The numerical value of L₁₆ is smaller than the numerical value of L₁₁, and the reflecting sheet 26 is arranged centrally on the reflecting plate 4 in the third direction. A distance between one end of the reflecting sheet 26 away from the reflecting plate 4 and the reflecting plate 4 is H, where 10 mm<H<15 mm. The antenna structure of the present example is provided with a reflecting sheet 26, and the reflecting sheet 26 can concentrate the beam reflection, so that some escape energy can be reflected back to a main direction through the reflecting sheet 26 to form an effect of beam superposition, thereby improving the gain, and improving the antenna performance without increasing the antenna profile.

In some exemplary embodiments, as shown in FIG. 28, the reflecting plate 4 is provided with a reflecting sheet 26 perpendicular to the reflecting plate 4, the reflecting sheet 26 and the reflecting plate 4 are provided as an integral piece, and the reflecting plate 4 is formed by bending a plate material of the reflecting sheet 26. The reflecting plate 4 is provided with a third edge 11, one end of the reflecting sheet 26 is connected to the third edge 11 and the other end of the reflecting sheet 26 extends away from the reflecting plate 4, and the reflecting sheet 26 can be perpendicular to the reflecting plate 4. A length of the reflecting sheet 26 may be configured to be inconsistent with an extension length of the third edge 11. The length of the reflecting sheet 26 is configured to be L₁₆, and the extension length of the third edge 11 is the same as a dimension L₁₁ of the reflecting sheet 26 in the third direction. The numerical value of L₁₆ is larger than the numerical value of L₁₁, so that the reflecting sheet 26 protrudes from the reflecting plate 4 at both ends in the third direction, and the reflecting sheet 26 is arranged centrally on the reflecting plate 4 in the third direction. A distance between one end of the reflecting sheet 26 away from the reflecting plate 4 and the reflecting plate 4 is H, where 10 mm<H<15 mm. The antenna structure of the present example is provided with a reflecting sheet 26, and the reflecting sheet 26 can concentrate the beam reflection, so that some escape energy can be reflected back to a main direction through the reflecting sheet 26 to form an effect of beam superposition, thereby improving the gain, and improving the antenna performance without increasing the antenna profile.

In some exemplary embodiments, a communication system including the antenna structure described above may be a device such as a base station. In particular, some display devices, for example, any product or component having a display function, such as a mobile phone, a tablet computer, a television, a display, a notebook computer, a digital photo frame, a navigator, and the like, can transmit or receive signals through the antenna structure.

In combination with the above embodiments, the antenna structure can realize omnidirectional coverage only by using the antenna assemblies 1 on both sides, and the minimum gain can reach 4 dB. Compared with the related dual-polarized omnidirectional antenna, this antenna structure has a smaller volume and a simpler structure on the basis of ensuring performance. The windward area of the antenna structure is small, much smaller than the standard area of 0.8 m², reducing the impact of the natural environment. The antenna structure is manufactured by printed circuit board process, which is low-cost and easy to manufacture, and the antenna structure has a low profile, effectively reducing the overall thickness of the antenna. The antenna structure is provided with a reflecting sheet 26, and the reflecting sheet 26 can concentrate the beam reflection, so that some escape energy can be reflected back to the main direction through the reflecting sheet 26 to form an effect of beam superposition, thereby improving the gain, and improving the antenna performance without increasing the antenna profile. The antenna structure adds a parasitic patch 25 and a foam pad 24 on the basis of having a radiation patch and a dielectric plate, which can add a new resonance point, so that the bandwidth can be effectively increased. The distance between the two antenna assemblies of the antenna structure can be reduced to 10 mm, the spacing between the two antenna assemblies is small, and the overall volume of the antenna structure can be effectively reduced, which is more conducive to catering to the trend of miniaturization and high gain products. In this antenna structure, the coupling effect between the antenna assemblies 1 on both sides can be improved by adding a through first slot 19 on the connector. In the antenna structure, by providing the second slot 16 in the radiation patch, the current distribution on the antenna is changed, and the length of the current path is increased, so that the antenna generates a resonance point with a resonant frequency lower than that of the antenna structure shown in FIG. 1, thereby expanding the bandwidth of the antenna.

The above described embodiments are only illustrative of several embodiments of the present disclosure, and the description thereof is more specific and detailed, but the contents described are only embodiments adopted for the convenience of understanding the present disclosure, and are not intended to limit the present disclosure. Any person skilled in the art to which the present disclosure pertains may make any modification and variation in implementation forms and details without departing from the spirit and scope disclosed in the present disclosure. However, the scope of patent protection of the present disclosure is still subject to the scope defined by the appended claims.

1. An antenna structure comprising two antenna assemblies spaced apart in a first direction, wherein the two antenna assemblies are configured to be symmetrical relative to a first plane located between the two antenna assemblies, and the first direction is configured to be perpendicular to the first plane; and
the antenna assemblies comprise at least two antenna units spaced apart, each antenna unit comprises a reflecting plate and a patch mechanism that are connected to each other, and the patch mechanism is located on a side of the reflecting plate facing away from the first plane.

2. The antenna structure according to claim 1, wherein the antenna assemblies further comprise a connector, reflecting plates of two adjacent antenna units are configured to be connected through the connector, and the two adjacent antenna units are configured to be symmetrical relative to the connector.

3. The antenna structure according to claim 2, wherein the reflecting plates of the at least two antenna units are located in a second plane and are spaced apart, the connector is configured to have a plate shape and is located in the second plane, and the second plane is parallel to the first plane.

4. The antenna structure according to claim 3, wherein the connector is provided as an integral piece with the reflecting plates of the two adjacent antenna units, and a thickness of the connector is the same as a thickness of the reflecting plate.

5. The antenna structure according to claim 3, wherein the connector is provided with a first slot that is configured to penetrate the connector in the first direction, and the first slot is arranged centrally on the connector; and
wherein the first slot comprises a plurality of first transverse slots and a plurality of first vertical slots, the plurality of first transverse slots are parallel to each other and arranged at equal intervals along a second direction, the plurality of first vertical slots are parallel to each other and arranged at equal intervals along a third direction, the plurality of first transverse slots and the plurality of first vertical slots intersect to form a mesh shape, and the first direction, the second direction and the third direction are configured to be perpendicular to each other.

6. (canceled)

7. The antenna structure according to claim 3, wherein two antenna units are provided, the two antenna units are spaced apart in a second direction, and reflecting plates of the two antenna units are each provided with a reflecting sheet perpendicular thereto, and the reflecting sheet and the reflecting plate are provided as an integral piece; and
an edge of the reflecting plate away from the connector in the second direction is provided as a third edge, one end of the reflecting sheet is connected with the third edge, the other end of the reflecting sheet extends away from the first plane, and the second direction is perpendicular to the first direction.

8. The antenna structure according to claim 7, wherein a length of the reflecting sheet is configured to be the same as an extension length of the third edge, and one end of the reflecting sheet away from the reflecting plate is configured to have a distance H from the reflecting plate, wherein 10 mm<H<15 mm.

9. The antenna structure according to claim 3, wherein the patch mechanism comprises a dielectric plate and a radiation patch, the radiation patch is configured to be parallel to the reflecting plate and to be spaced apart from the reflecting plate in the first direction, the dielectric plate is sandwiched between the radiation patch and the reflecting plate, and both the dielectric plate and the radiation patch are configured to be arranged centrally relative to the reflecting plate; and
the radiation patch has two feeding ports rotationally symmetrical at 90° relative to a geometric center of the radiation patch.

10. The antenna structure according to claim 9, wherein a projection of the dielectric plate on the first plane is configured to be located within a projection of the reflecting plate on the first plane, and a projection of the radiation patch on the first plane is located within the projection of the dielectric plate on the first plane.

11. The antenna structure according to claim 9, wherein the reflecting plate, the dielectric plate, and the radiation patch are all configured as a plate-like structure, edges of the connector at both ends in a second direction are provided as first edges, the first edges are configured to be connected with the reflecting plate, and an extension length of each first edge is configured to be equal to or less than an extension length of an edge of the reflecting plate close to the connector.

12. The antenna structure according to claim 11, wherein the radiation patch is provided with a second slot, and the second slot is arranged centrally on the radiation patch and penetrates the radiation patch.

13. The antenna structure according to claim 12, wherein the second slot is provided as a cross-shaped slot, and the cross-shaped slot comprises a second transverse slot and a second vertical slot that intersect; and
wherein slot widths of the second transverse slot and the second vertical slot are both configured to be 1 mm to 2 mm, slot lengths of the second transverse slot and the second vertical slot are both configured to be L₁, the second transverse slot or the second vertical slot is configured to extend in the second direction, and an extension length of the radiation patch in the second direction is configured to be L₂, wherein L₁:L₂=1:2, and the second direction is configured to be perpendicular to the first direction.

14. (canceled)

15. The antenna structure according to claim 9, wherein a metal member is provided between the radiation patch and the reflecting plate, the radiation patch and the reflecting plate are configured to be electrically connected via the metal member, and the metal member is embedded in the dielectric plate.

16. The antenna structure according to claim 15, wherein the metal member is provided as a metal sheet, the metal sheet is perpendicular to the reflecting plate and the radiation patch and is attached to the reflecting plate and the radiation patch at both ends in the first direction, and the dielectric plate is provided with an embedding slot for accommodating the metal sheet; and
one edge of the radiation patch in a third direction is provided as a second edge, the two feeding ports are configured to be away from the second edge, the metal sheet extends along the third direction, the metal sheet is configured to be centrally arranged in a second direction relative to the radiation patch, one end of the metal sheet is flush with the second edge, and the first direction, the second direction, and the third direction are configured to be perpendicular to each other.

17. The antenna structure according to claim 9, wherein the patch mechanism further comprises a parasitic patch and a foam pad, the parasitic patch is located on a side of the radiation patch facing away from the reflecting plate, the parasitic patch is parallel to the radiation patch and is spaced apart from the radiation patch in the first direction, and the foam pad is sandwiched between the parasitic patch and the radiation patch.

18. The antenna structure according to claim 17, wherein both the parasitic patch and the foam pad are configured to have a square plate shape;
a projection of the radiation patch on the first plane is located in a projection range of the parasitic patch on the first plane; and
a projection of the foam pad on the first plane is the same as the projection of the radiation patch on the first plane.

19. The antenna structure according to claim 9, wherein the feeding ports are coaxial feeding ports, and a phase difference between the two feeding ports is 180°; or
wherein one end of the feeding ports penetrates the radiation patch and is welded to the radiation patch at an end face of the radiation patch facing away from the reflecting plate, and the other end of the feeding ports penetrates the reflecting plate.

20. (canceled)

21. The antenna structure according to claim 1, wherein a distance between the two antenna assemblies is configured to be 10 mm to 50 mm.

22. The antenna structure according to claim 2, wherein in one of the antenna assemblies, a total area of a projection of the connector and the reflecting plate of the antenna unit on the first plane is configured to be 0.1 m² to 0.15 m².

23. A communication system comprising the antenna structure according to claim 1.
